(19) United States
(12) Patent Application Publication
(10) Pub. No.: US 2024/0006780 A1
(43) Pub. Date: Jan. 4, 2024

(54) Electrical Connection Device and Method of Manufacturing the Same

(71) Applicant: TE Connectivity Germany GmbH, Bensheim (DE)

(72) Inventors: Alfons Ketteler, Bensheim (DE); Gregor Karrasch, Bensheim (DE); Joerg Bieber, Bensheim (DE)

(73) Assignee: TE Connectivity Germany GmbH, Bensheim (DE)

(21) Appl. No.: 18/344,496

(22) Filed: Jun. 29, 2023

(30) Foreign Application Priority Data
Jun. 30, 2022 (DE) 102022116368.7

(51) Int. Cl. H01R 4/20; H01R 4/02; H01R 43/048

(52) U.S. Cl. CPC H01R 4/20; H01R 4/029; H01R 43/048

(57) ABSTRACT

An electrical connection device includes a cable and an electrical plug device. The electrical plug device has a crimping element with a crimping sleeve crimped on the cable. A pair of legs of the crimping sleeve that are bent toward one another to enclose the cable are welded together.

### CROSS-REFERENCE TO RELATED APPLICATIONS

This application claims the benefit of the filing date under 35 U.S.C. § 119(a)-(d) of German Patent Application No. 102022116368.7, filed on Jun. 30, 2022.

### FIELD OF THE INVENTION

The present invention relates to an electrical connection device and a method of manufacturing the same.

### BACKGROUND

An electrical connection device has an electrical plug device and a cable associated with the electrical plug device, usually comprising a shielding. The electrical plug device is configured with correct impedance, i.e. adapted to make electrical contact with the shielding, and has a crimping element for this purpose, comprising a crimping sleeve. This crimping sleeve crimps the cable such that the crimping sleeve is electrically connected to the shielding. Such electrical connection devices are known in particular in the automotive industry. The shielding is intended to reduce or eliminate electromagnetic interference, especially in data lines, which can influence the flow of information through at least one conductor.

The crimping element is usually used at least as strain relief and for mechanical coupling of the electrical plug device to the cable. For this purpose, the crimping element regularly has an attachment section that is connected to an electrically insulating housing, usually made of plastic, of the electrical plug device. In this context, this attachment section can cause not only the mechanical coupling with the housing, but it can also be arranged on or in the housing such that the shielding of the cable by the crimping element is continued entirely or partially in the plug device, so that two plug devices shield the plug contact elements to the outside after the two plug devices have been plugged in.

At least the mechanical coupling between the housing of the plug device and the cable is subject to a certain mechanical stress. Sometimes, the plug device is introduced to the associated mating plug device in the wrong direction. This results in the need to pivot the plug device 180 degrees relative to the mating plug device, which is accompanied by torsion of the cable already attached to the other end. This torsion of the cable can lead to bending up of the legs of the crimping sleeve, which are placed around the outer circumference of the cable.

### SUMMARY

An electrical connection device includes a cable and an electrical plug device. The electrical plug device has a crimping element with a crimping sleeve crimped on the cable. A pair of legs of the crimping sleeve that are bent toward one another to enclose the cable are welded together.

### BRIEF DESCRIPTION OF THE DRAWINGS

Further details and advantages of the present invention will be apparent from the following description of embodiments in conjunction with the drawings. Therein:

FIG. 1 is a perspective view of an electrical connection device before welding;

FIG. 2 is a perspective view of a crimping sleeve of the electrical connection device of FIG. 1;

FIG. 3 is a sectional end view taken along line III-III of FIG. 1; and

FIG. 4 is a top view of the crimping sleeve after welding.

### DETAILED DESCRIPTION OF THE EMBODIMENT(S)

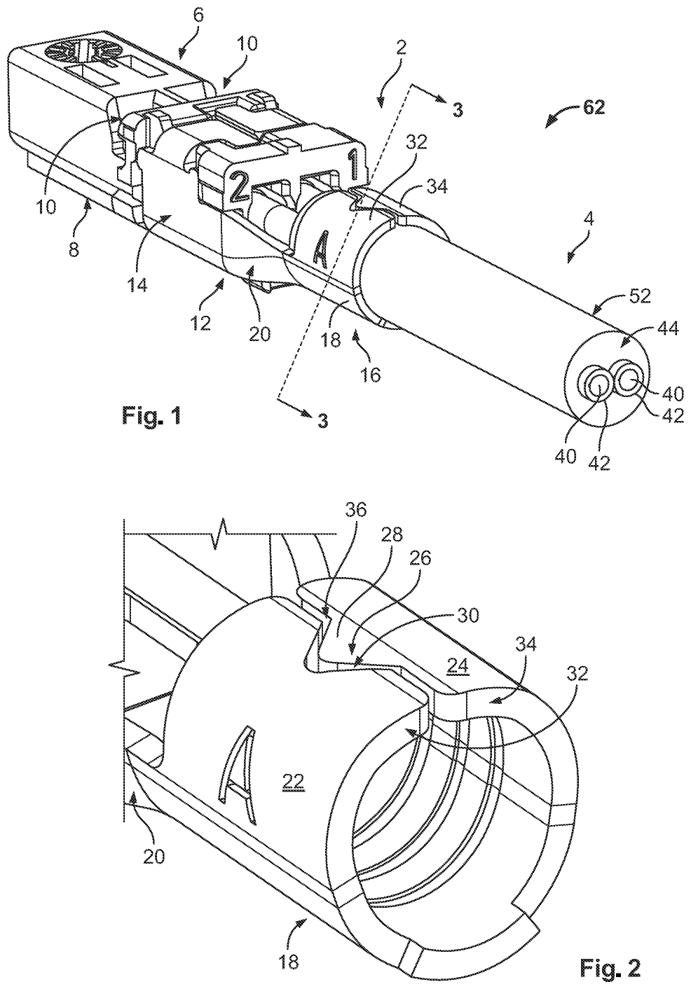

FIG. 1 shows a perspective side view of an embodiment of an electrical connection device 2, which comprises a cable 4 and an electrical plug device 6. The electrical plug device 6 has a housing 8 made of plastic, in which two contact element chambers 10 are configured, each of which receives plug contact elements not shown inside the housing 8 and positions them against one another. The contact element chambers 10 may have boundary surfaces that provide the necessary or desired clearance and creepage distances. The housing 8 may also be referred to as a chamber housing. For the basic structure of the electrical connection device 2, reference is made to EP 3 046 189 B1.

A crimping element 12 includes an attachment section 14 which is placed around the housing 8 in a form-fitting manner and by crimping, and a crimping sleeve 16 which is connected to the cable 4 by crimping. In the embodiment shown, the crimping sleeve 16 has a shell 18 formed in a substantially semi-circular shape, which joins a connection section 20 provided between the attachment section 14 and the crimping sleeve 16. Legs 22, 24 of the crimping sleeve 16 protrude from the shell 18, which after bending provide a substantially circumferentially closed configuration that is placed circumferentially around the outside of the cable 4 (as shown in FIG. 1).

In FIG. 2, in an engagement area 26, one leg 24 has a wedge-shaped protrusion 28 which engages in a wedge-shaped groove 30 of the other leg 22. This results in an overlap of end regions 32, 34 of the corresponding legs 22, 24 at right angles to the direction of longitudinal extension of the cable 4. Such interlocking end contours create an engagement of the free ends of the legs 22, 24 in the circumferential direction. One leg 22, 24 can have at least one U- or V-shaped adapted recess in which a corresponding protrusion of the other leg engages. A slot-shaped gap 36 is between the free ends of the legs 22, 24. The legs 22, 24 are usually dimensioned so that they abut or end immediately adjacent to each other.

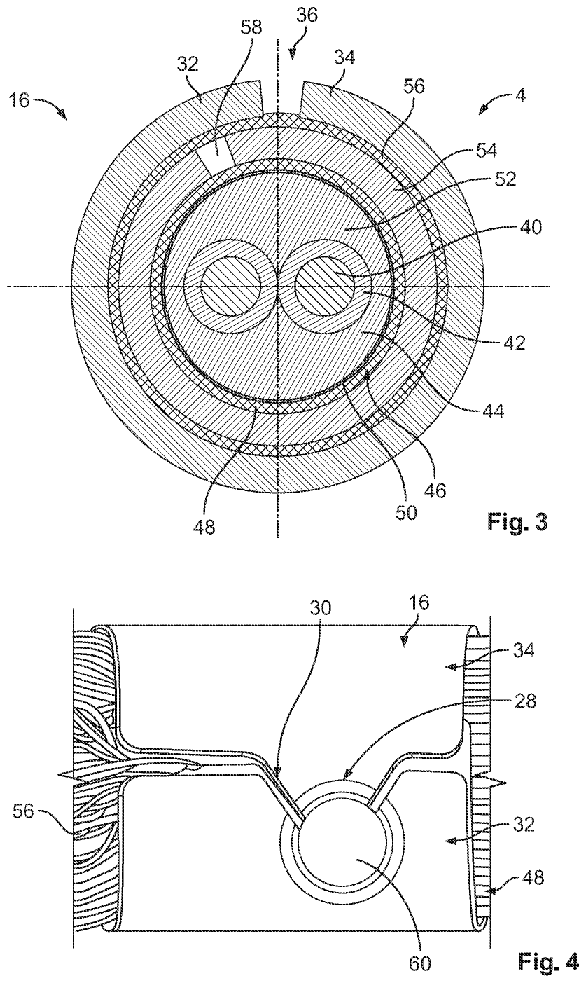

FIGS. 1 and 3 show details of the cable 4. The cable 4 has two conductors 40, each surrounded by an insulation 42. The conductors 40 are electrical conductors. The conductors 40 are received in an inner sheath 44 surrounding each of the insulations 42. The inner sheath 44 is sometimes referred to as a filler or dielectric.

A conductor 40 within the meaning of the present invention may be a metallic conductor, for example, made of aluminum. However, a conductor 40 within the meaning of the present invention may also be a light conductor based on plastic or glass. The cable 4 may combine electrical conductors and light conductors.

The inner sheath 44 is surrounded on the outside by a shielding 46, shown in FIG. 3, which includes a shielding braid 48 and a metallic film 50 provided between the shielding braid 48 and the inner sheath 44. This structure surrounds a cable sheath 52.

FIG. 3 shows a support sleeve 54, which is applied to the shielding 46 by crimping after the cable sheath 52 has been removed at least at the end. After the cable sheath 52 has been cut off, the shielding braid 48 is usually brought to length. The film protruding beyond the inner sheath 44 in the longitudinal direction of the cable 4 is cut off. The shielding braid 48 is cut to length so that an end region protrudes longitudinally beyond the inner sheath 44. This exposed end region 56, shown in FIG. 4, is already folded over around the support sleeve 54. The folded over end region 56 of the shielding braid 48 surrounds the support sleeve 54. In other words, the support sleeve 54 is provided between the shielding braid 48 provided on the outside of the inner sheath 44 and the exposed end region 56. As can be seen from FIG. 3, the free ends of the support sleeve 54 in the circumferential direction do not abut against each other. Rather, there is also a gap 58 between these free ends. In contrast, the gap 36 of the crimping sleeve 16 is spaced apart in the circumferential direction.

As shown in FIG. 4, a welding spot 60 is set in this gap 36 by laser welding, which connects the two end regions 32, 34 of the legs 22, 24 to each other. The melted material of the welding spot 60 extends radially into the support sleeve 54 and also connects the support sleeve 54 to the crimping sleeve 16. In view of the material properties of the cable sheath, welding should be carried out with as little thermal input as possible.

The welding spot 60 connects the usually free ends of the legs 22, 24 to each other to form a circumferentially closed crimping sleeve. This creates a connection between the electrical plug device 6 and the cable 4 that has high strength. The cable 4 is secured with good pull-out resistance to the electrical plug device 4. Torsion of the cable 4, which leads to a corresponding load within the crimping sleeve 16, cannot force the two end regions 32, 34 of the legs 22, 24 away from each other. The crimp connection via the crimping sleeve 16 is positioned securely due to the material connection of the two legs 22, 24 and withstands a corresponding torsional stress. Thus, the crimping sleeve 16 remains abutted against the outer circumferential surface of the cable 4.

Accordingly, due to the crimping process, the crimping sleeve 16 not only encloses the cable 4 with a certain pretension and/or in a form-fitting manner. Rather, the form-fitting embrace is secured by the welded connection at the welding spot 60. This makes the mechanical connection between the cable and the crimping sleeve more robust. In principle, the invention is applicable to any circumferentially open crimp, be it a round crimp or a polygonal crimp.

In an embodiment, at least one, usually punctual, weld can also be provided at a point in the circumferential direction other than the ends of the legs 22, 24. At least in this variant, the crimping sleeve 16 does not have to completely surround the cable 4. It is sufficient if the crimping sleeve 16 encloses a partial circumference of the cable 4.

A support sleeve 54 can also be laid under the crimping sleeve 16 merely to protect the cable 4. The support sleeve 54 does not have to be welded to the crimping sleeve 16. However, by welding, a higher robustness against torsional load is achieved.

When the crimping sleeve 16 is welded to the support sleeve 54, the welded connection penetrates the shielding. In the process, the individual strands of the shielding braid 48 can also be welded on and dissolve in the welded connection. However, it is also sufficient for good attachment to merely melt material of the support sleeve 54 and the crimping sleeve 16 during welding and to let the melt solidify penetrating the shielding. The extent of melting of the shielding braid 48 depends on the welding energy. This is selected so that a secure material connection is created between the support sleeve 54 and the crimping sleeve 16. However, it has to be considered that the inner sheath 44 does not suffer any thermal damage that would affect the conductor(s) inside the inner sheath 44.

The support sleeve 54 is at the same level as the crimping sleeve 16 and is thus radially underlaid. The support sleeve 54 protects the cable conductor 40 located underneath the support sleeve 54 and its insulation from excessive thermal stress, for example during welding. In this context, it usually has to be considered that the welding area is underlaid by a circumferentially closed area of the support sleeve 54. The support sleeve 54 also has a slot resulting from crimping around the cable 4. This should not be located in the welding area.

Welding the free ends of the crimping sleeve legs 22, 24 bent towards each other already prevents bending up under torsional stress. However, increased strength of the crimp connection results from the fact that a corresponding welded connection of the free ends of the legs 22, 24 extends radially to the support sleeve 54 and accordingly connects the support sleeve 54 to the bent legs 22, 24. This creates a significantly greater pull-out resistance of the exposed end region from the annular space between the crimping sleeve 16 and the support sleeve 54. This not only improves the resistance of the crimping sleeve 16 to bending up under torsional stress, but also increases the pull-out resistance of the exposed end region 56. The mechanical coupling between the electrical plug device 6 and the cable 4 and thus the pull-out resistance of the cable 4 from the electrical plug device 6 is then considerably improved.

In FIG. 1, the embodiment shown is part of a wiring harness 62 for a motor vehicle. The housing 8 has a rectangular cross-sectional shape. In the event of improper alignment with a corresponding plug device, in this case a female plug element of a plug connector, the cable may have to be pivoted 180 degrees about its longitudinal axis. Such a torsion does not cause the crimping sleeve 16 to expand.

Any welded connection according to the present invention may be realized by one or more welding spots. The welding spots may be spaced apart relative to each other in the longitudinal direction and/or circumferential direction of the cable 4.

What is claimed is:

1. An electrical connection device, comprising:
a cable; and
an electrical plug device having a crimping element with a crimping sleeve crimped on the cable, a pair of legs of the crimping sleeve that are bent toward one another to enclose the cable are welded together.

2. The electrical connection device of claim 1, further comprising a support sleeve disposed under the crimping sleeve.

3. The electrical connection device of claim 1, wherein the legs of the crimping sleeve have a pair of interlocking end contours.

4. The electrical connection device of claim 3, wherein the legs are welded in an engagement region of the interlocking end contours.

5. An electrical connection device, comprising:
a cable having a shielding;
an electrical plug device having a crimping element electrically contacting the shielding, the crimping element has a crimping sleeve; and
a support sleeve disposed between the shielding and an exposed end region of the shielding, the crimping sleeve is positioned around an outer circumference of the cable and encloses the exposed end region, the crimping sleeve is welded to the support sleeve.

6. A wiring harness, comprising:
an electrical connection device including a cable and an electrical plug device having a crimping element with a crimping sleeve crimped on the cable, a pair of legs of the crimping sleeve that are bent toward one another to enclose the cable are welded together.

7. A method of manufacturing an electrical connection device, comprising:
providing a cable and an electrical plug device, the electrical plug device has a housing, a plug contact element, and a crimping element with a crimping sleeve;
connecting the crimping element to the cable by crimping a pair of legs of the crimping sleeve around the cable; and
welding the legs of the crimping sleeve to one another.

8. The method of claim 7, wherein the welding is performed with a laser.

9. The method of claim 8, further comprising connecting a support sleeve to the cable by crimping.

10. The method of claim 9, wherein the legs of the crimping sleeve are welded together at a level of the support sleeve.

11. The method of claim 10, further comprising a cable having a conductor and an inner sheath surrounding the conductor.

12. The method of claim 11, wherein the inner sheath is surrounded by a shielding, which is surrounded by a cable sheath.

13. The method of claim 12, wherein a section of the cable sheath is removed, a shielding braid of the shielding is cut to length, a section of the inner sheath is removed, and the crimping element is connected to the cable while enclosing the shielding.

14. The method of claim 13, wherein the legs of the crimping sleeve abut against an outer circumference of the shielding.

15. The method of claim 13, wherein the crimping sleeve is welded to an end region of the shielding that is exposed after the cable sheath has been cut.

16. The method of claim 13, wherein the crimping sleeve is welded to the support sleeve.

17. The method of claim 13, wherein, after the shielding braid has been cut, a film disposed between the shielding braid and the inner sheath is cut off.

18. The method of claim 13, wherein, after the inner sheath has been cut, the plug contact element is connected to the conductor and arranged in a contact element chamber of the housing.
